(19) United States
(12) Patent Application Publication
(10) Pub. No.: US 2009/0167644 A1
(43) Pub. Date: Jul. 2, 2009

(54) RESETTING DRIVE TRANSISTORS IN ELECTRONIC DISPLAYS

(76) Inventors: Christopher J. White, Avon, NY (US); Felipe A. Leon, Rochester, NY (US); Charles I. Levey, West Henrietta, NY (US); Bruno Primerano, Honeoye Falls, NY (US)

Correspondence Address: Frank Pincelli;Patent Legal Staff, Eastman Kodak Company, 343 State Street, Rochester, NY, 14650-2201, US

(21) Appl. No.: 11/965,847

(22) Filed: Dec. 28, 2007

(51) Int. Cl. G09G 3/30

(52) U.S. Cl. 345/76

(57) ABSTRACT

A method for resetting drive transistors associated with subpixels in an electroluminescent display, comprising providing an electroluminescent display having a plurality of subpixels, each subpixel including an electroluminescent device and a drive circuit having a drive transistor for providing current through its associated electroluminescent device; providing a separate aging signal for each subpixel during operation of the electroluminescent display after a predetermined operating time period by responding as a function of the current passing through each of the subpixels or as a function of a voltage associated with each drive circuit; comparing each of the separate aging signals with a corresponding threshold level to produce a separate staleness signal for each subpixel representing whether or not the associated drive transistor should be reset; and resetting the associated drive transistors in response to staleness signals that indicate such drive transistors should be reset.

### CROSS-REFERENCE TO RELATED APPLICATIONS

Reference is made to commonly-assigned U.S. patent application Ser. No. 11/962,182, filed Dec. 21, 2007, entitled “Electroluminescent Display Compensated Analog Transistor Drive Signal” to Leon et al.; and commonly assigned U.S. patent application Ser. No. 11/766,823, filed Jun. 22, 2007, entitled “OLED Display With Aging and Efficiency Compensation” to Levey et al., the disclosures of which are herein incorporated by reference.

### FIELD OF THE INVENTION

The present invention relates to solid-state electroluminescent displays and more particularly to resetting drive transistors in such displays.

### BACKGROUND OF THE INVENTION

Solid-state electroluminescent (EL) displays are of great interest as an improved flat-panel display technology. These displays use current passing through thin films of material to generate light. Organic light-emitting diode (OLED) displays are a particularly promising technology employing thin films of organic material to generate the light. The color of light emitted and the efficiency of the energy conversion from current to light are determined by the composition of the organic thin-film material. Different organic materials emit different colors of light. A display can be formed as an array of pixels, each of which comprises one or more subpixels. For a color display, each subpixel can emit a different color of light.

In active-matrix OLED (AMOLED) and other active-matrix electroluminescent displays, current is typically supplied to the organic materials by drive transistors; these are generally thin-film transistors (TFTs). These TFTs are frequently made of amorphous silicon (a-Si), for example, as taught by Tanaka et al. in U.S. Pat. No. 5,034,340. Amorphous silicon is inexpensive and easy to manufacture. However, it is metastable: over time, as voltage bias is applied to the gate of an a-Si TFT, its threshold voltage (Vₜₕ) shifts, thus shifting its I-V curve (Kagan & Andry, ed. Thin-film Transistors. New York: Marcel Dekker, 2003; Sec. 3.5, pp. 121-131). Vₜₕ typically increases over time under forward bias, so over time, Vₜₕ shift will, on average, cause a display to dim. This reduces the lifetime of the display. In addition, since the rate of Vₜₕ shift depends on applied bias, each individual subpixel can age at a rate different from other subpixels, resulting in display nonuniformity and visible image stick. This is a significant effect; most of the luminance loss of modern a-Si AMOLED displays is a result of changes in the amorphous silicon TFT performance rather than changes in the OLED.

The lack of stability in a-Si TFTs has been studied. For example, in an article entitled “Stability issues in digital circuits in amorphous silicon technology” published in Electrical and Computer Engineering, 2001, Vol. 1, pp. 583-588 by Mohan et al., the article discusses the fact that the Vₜₕ of an a-Si TFT can shift by as much as 2V when driven with a +20V bias for even 600 hours. This type of positive bias drive voltage is common for driving an OLED and this large threshold voltage shift can have a dramatic influence on the light output of the display. This same paper discusses the fact that negative bias can have the opposite effect and, more importantly, that by cycling between a positive and negative bias, the rate of threshold shift can be decreased dramatically. For example, by oscillating bias between +20V and −20V, threshold shifts on the order of only 0.8 V can be demonstrated over time scales as long as 40,000 hours. Such methods have been demonstrated successfully on other technologies, such as liquid-crystal displays. The use of reverse bias can reset the drive transistor, removing all the Vₜₕ shift due to forward bias, or slow the degradation of the drive transistor, by periodically removing some of the Vₜₕ shift due to forward bias.

Unfortunately, EL displays, such as OLED, typically perform as a diode, allowing appreciable levels of current to flow and light to be created only when driven in a forward bias. Therefore, known methods use both forward and reverse bias to slow the degradation of a-Si drive TFTs when driving an EL device. These schemes typically involve a first period during which the drive TFT is driven in forward bias and emits light and a second period during which the drive TFT is driven in reverse bias and therefore does not emit light. This means that the EL device is driven with less than 100% of the possible duty cycle.

For example, Lo et al., in U.S. Pat. No. 7,116,058, teach modulating the reference voltage of the storage capacitor in an active-matrix pixel circuit to reverse-bias the drive transistor between each frame. Sanford et al., in U.S. Pat. No. 6,734,636, teach modulating one of the supply voltages to an AMOLED panel to reverse-bias the drive transistor while storing data that will be subsequently driven. Andry et al., in U.S. Pat. No. 6,872,974, teach varying the voltage and duration of a reverse bias to remove Vₜₕ shift, where the duration is between about 1% and 99.9% of a frame time. Tsuchida, in US 2006/0187154 A1, teaches applying reverse bias less often than per-frame, and specifically every predetermined number of frames. Libsch et al., in U.S. Pat. No. 7,167,169, teach a panel configuration using reverse bias within a frame. Howard, in U.S. Pat. No. 6,858,989, teaches applying to each subpixel a reverse bias that depends on the forward bias that was applied to that subpixel.

In all these schemes, however, since each light-emitting element only emits light when its drive TFT is not reverse biased, the duty cycle of light emission is less than 100%. Therefore, the drive TFT must operate at higher voltage during forward bias to achieve the same luminance it could with 100% duty cycle, which can actually lead to faster TFT degradation. Further, the reduced duty cycle requires the EL device be driven at a higher instantaneous current density, which can reduce the lifetime of the EL device faster than it would have using a traditional forward bias only driving scheme. Additionally, compared to conventional two-transistor, one-capacitor (2T1C) AMOLED backplane designs, these schemes require more complicated external power supplies, additional pixel circuitry or additional signal lines.

Alternative schemes use reverse bias in a separate phase than light emission. One such scheme is described by Hasumi et al., in “New OLED Pixel Circuit and Driving Method to Suppress Threshold Voltage Shift of a-Si:H TFT,” SID 2006 Digest paper 46.2, pgs. 1547-1550. Hasumi et al. apply reverse bias when a display is off in order to slow Vₜₕ shift. However, they apply reverse bias frequently, for example, for one minute out of every eleven. While such a model can be appropriate for cell phone displays or other displays with intermittent usage, it does not apply to monitor or television applications, or to long-duration portable applications such as personal video players. Such applications cannot tolerate frequent interruptions of the image being shown by the display. Yoshida et al., in US 2005/0212408 A1, teach the use of reverse bias when the display is off to repair defects. However, their scheme does not correct for Vₜₕ shift, and does not allow reverse-biasing only. Similarly, Lin et al., in US 2006/0267888 A1, teach reverse bias to slow degradation. However, their scheme does not allow applying reverse bias to some subpixels but not others.

There is a need, therefore, for an improved way of employing reverse bias to compensate for the degradation of a-Si drive transistors in active-matrix electroluminescent displays.

### SUMMARY OF THE INVENTION

In accordance with the present invention, there is provided a method for resetting drive transistors associated with subpixels in an electroluminescent display, comprising:

a) providing an electroluminescent display having a plurality of subpixels, each subpixel including an electroluminescent device and a drive circuit having a drive transistor for providing current through its associated electroluminescent device;

b) providing a separate aging signal for each subpixel during operation of the electroluminescent display after a predetermined operating time period by responding as a function of the current passing through each of the subpixels or as a function of a voltage associated with each drive circuit;

c) comparing each of the separate aging signals with a corresponding threshold level to produce a separate staleness signal for each subpixel representing whether or not the associated drive transistor should be reset; and

d) resetting the associated drive transistors in response to staleness signals that indicate such drive transistors should be reset.

In another aspect of the present invention, there is provided apparatus for resetting drive transistors associated with subpixels in an electroluminescent display, comprising:

a) an array of subpixels, each subpixel including an electroluminescent device and a drive circuit having a drive transistor for providing current through its associated electroluminescent device;

b) means effective after a predetermined operating time cycle of the electroluminescent display for producing a separate aging signal for each subpixel that is a function of current passing through its associated drive transistor or voltage associated with its associated drive circuit;

c) means for comparing each of the separate aging signals with a corresponding threshold level to produce a separate staleness signal for each subpixel indicating whether or not its associated drive transistor should be reset; and

d) means employing reverse bias to reset the drive transistors associated with staleness signals that indicate such drive transistors should be reset.

### ADVANTAGES

The present invention provides a simple way of resetting drive transistors in an active-matrix EL display that does not reduce peak luminance. A feature of the present invention is that it compensates for aging but does not cause any significant increase in aging. It can be applied to television and other long on-time applications in order to compensate for aging without requiring interruption of the image display at times when the user cannot accept interruption.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a diagram of a typical EL display according to the prior art;

FIG. 2 is a diagram of an apparatus according to the present invention;

FIG. 3 is a plot of threshold voltage shift over time;

FIG. 4 is a diagram of a representative subpixel according to the prior art;

FIG. 5 is a diagram of a subpixel with a measurement circuit; and

FIG. 6 is a diagram of a subpixel with a second measurement circuit.

### DETAILED DESCRIPTION OF THE INVENTION

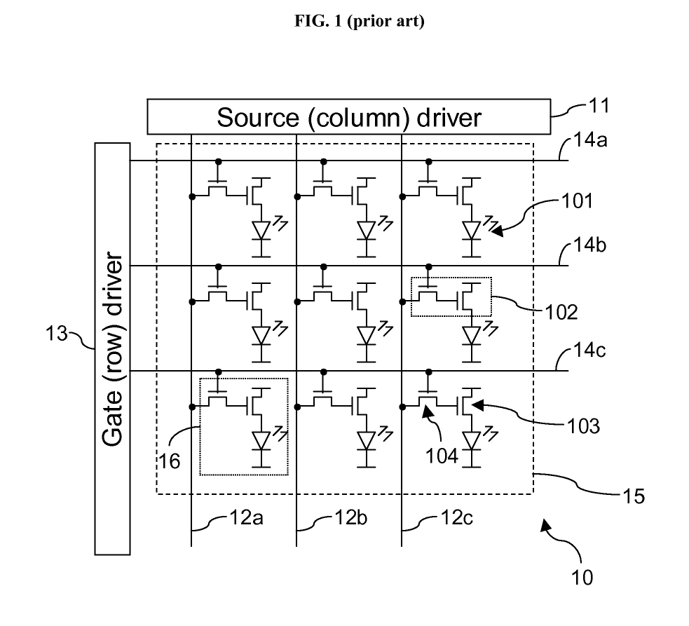

Referring to FIG. 1, a conventional electroluminescent (EL) display 10 has three main components: a source driver 11 driving column lines 12a, 12b, 12c, a gate driver 13 driving row lines 14a, 14b, 14c, and a subpixel matrix 15. This display can be, for example, an OLED display. Note that the source and gate drivers can comprise one or more ICs. Note also that the terms “row” and “column” do not imply any particular orientation of the EL display. The subpixel matrix comprises a plurality of subpixels 16, which are generally identical and arranged in an array of rows and columns. Each subpixel comprises an electroluminescent device 101, which can be for example an OLED device, and a drive circuit 102. Drive circuit 102 includes a drive transistor 103 for providing current through its associated electroluminescent device, and a select transistor 104 for providing a potential driven by the source driver 11 on a column line (for example 12a) to the gate electrode of the drive transistor 103.

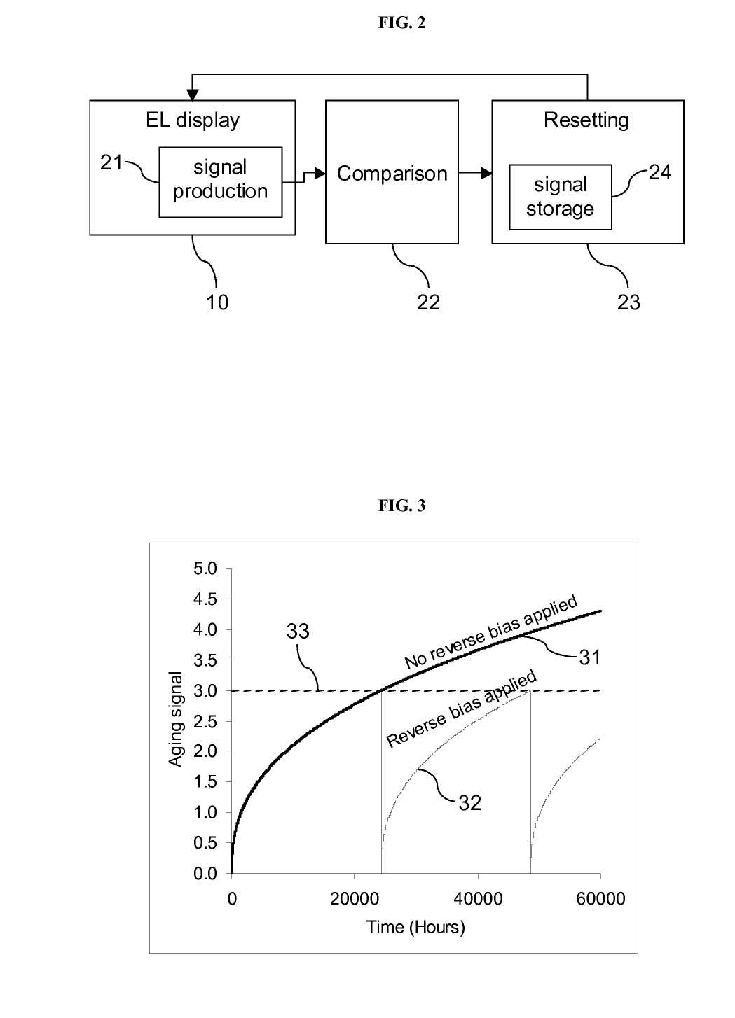

Referring to FIG. 2, according to the present invention, an apparatus for resetting drive transistors associated with subpixels in an electroluminescent display includes comparison circuitry 22, resetting circuitry 23, and an EL display 10 including signal-production circuitry 21. EL display 10 has an array of subpixels as shown on FIG. 1, each subpixel including an electroluminescent device 101 and a drive circuit 102 having a drive transistor 103 for providing current through its associated electroluminescent device. Signal-production circuitry 21 is effective after a predetermined operating time cycle of the electroluminescent display, and produces a separate aging signal for each subpixel. The predetermined operating time cycle can be selected based on the expected use of the display. It can also be calculated based on measurements of the aging signals, so that the time cycle can be adjusted as the EL display ages. The aging signal for a subpixel can be a function of current passing through its associated drive transistor or voltage associated with its associated drive circuit. Comparing circuitry 22 can compare each of the separate aging signals with a corresponding threshold level to produce a separate staleness signal for each subpixel indicating whether or not its associated drive transistor should be reset. There can be one threshold level for all subpixels or one for each color of subpixels. There can alternatively be a separate threshold for each subpixel. Threshold levels can also be set based on the location of a subpixel on a display. Resetting circuitry 23 can, in response to the staleness signals, reset those drive transistors associated with staleness signals indicating they should be reset; this can be accomplished using reverse bias of the drive transistors. Drive transistors which should be reset, and their containing subpixels, will hereinafter be referred to as “stale”; those which should not be reset, and their containing subpixels, will hereinafter be referred to as “fresh.” Note that “fresh” does not imply “new”; fresh transistors can have any amount of aging up to the threshold level. Note also that circuitry 21, 22, and 23 can all comprise digital logic, analog electronics, microcontrollers and software, programmable logic, or other hardware types known in the art.

Co-pending applications U.S. Ser. No. 11/962,182 by Leon et al. and U.S. Ser. No. 11/766,823 describe methods for reducing visible burn-in due to Vₜₕ shift and other aging factors while the display is operating. Consequently, the present invention, used in combination with the above-referenced applications, can allow aging to occur during normal operation and only reset drive transistors after a predetermined operating time, or at one or more times determined by the condition of the display. Where previous methods combined reverse bias with normal operation, the present invention performs reverse bias apart from normal operation. This advantageously provides increased duty cycle and reduced complexity compared to prior art methods.

Referring to FIG. 3, curve 31 shows a representative curve of an aging signal, for example shift in Vₜₕ (ΔVₜₕ, volts), over a typical display lifetime of 50,000 hours. In this example, Vₜₕ can shift around 4V in 50,000 hours. Line 33 represents a selected threshold level of 3. Curve 32 shows the result when the transistor is reset whenever the aging signal exceeds the threshold level. In this case, the staleness signal is false when the aging signal is less than or equal to the threshold level, and true when the aging signal is greater than the threshold level. Any transistor with a true staleness signal is reset. In this example, over the lifetime of the panel, reverse bias is used twice, keeping the Vₜₕ shift at or below 3V at all times. This reduces by 1V the headroom required in the display drivers, reducing their cost and power dissipation. Note that FIG. 3 shows only one curve using reverse bias. However, as discussed above, each subpixel's drive transistor can be reset when indicated by the staleness signal for that subpixel. Therefore, any time reverse bias is applied; one or more subpixels on the display can be reset. Fresh subpixels, those whose staleness signals do not indicate they should be reset, can be operated so they are not reset with the stale subpixels, as will be described below.

In the example of curve 32, reverse bias is performed only twice in the lifetime of the display. Reverse bias can be performed while the display is not in use for displaying images, such as at night or other times when the display is off. The present invention therefore does not reduce the duty cycle with which the EL device is driven, so advantageously does not increase the required drive voltage or instantaneous current density.

Referring back to FIG. 2, resetting a drive transistor can take an amount of time dependent on the amount of Vₜₕ shift and the conditions of reverse bias applied. For example, since reverse bias can be performed when the display is off, the resetting circuitry 23 can reverse bias each drive transistor in a time period greater than one frame time. When reverse bias is performed when the display is off, a user's turning on the display can interrupt the reverse bias. The resetting circuitry 23 can include storage circuitry 24 for tracking which subpixels have been interrupted in the middle of a reverse bias cycle and resume reverse bias when the display is turned off. In this way a drive transistor can be completely reset regardless of how long resetting takes. Storage circuitry 24 can store a progress signal representing that a drive transistor should be reverse biased so that resetting circuitry 23 can apply such reverse bias during one or more time periods when the display is not operating. The progress signal for each subpixel can be the staleness signal, or another a yes-or-no value indicating whether the subpixel is stale. It can alternatively be a counter tracking how long reverse bias has been applied to the subpixel. Alternatively, while reverse bias is applied to a drive transistor, a controller can periodically stop reverse bias, measure the aging signal associated with that transistor, and resume reverse bias if the updated staleness signal does not indicate the transistor has been reset.

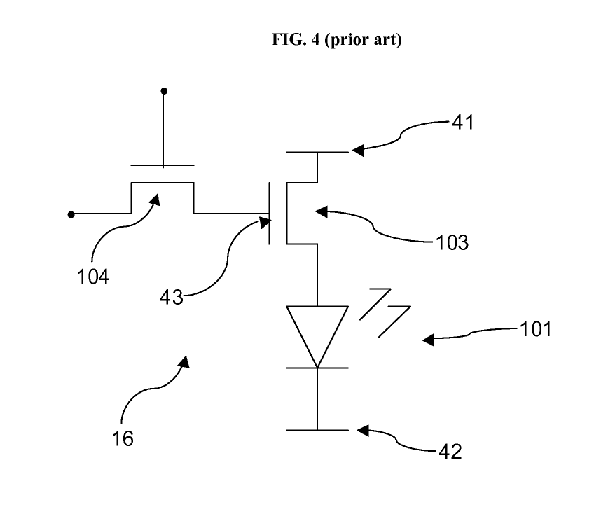

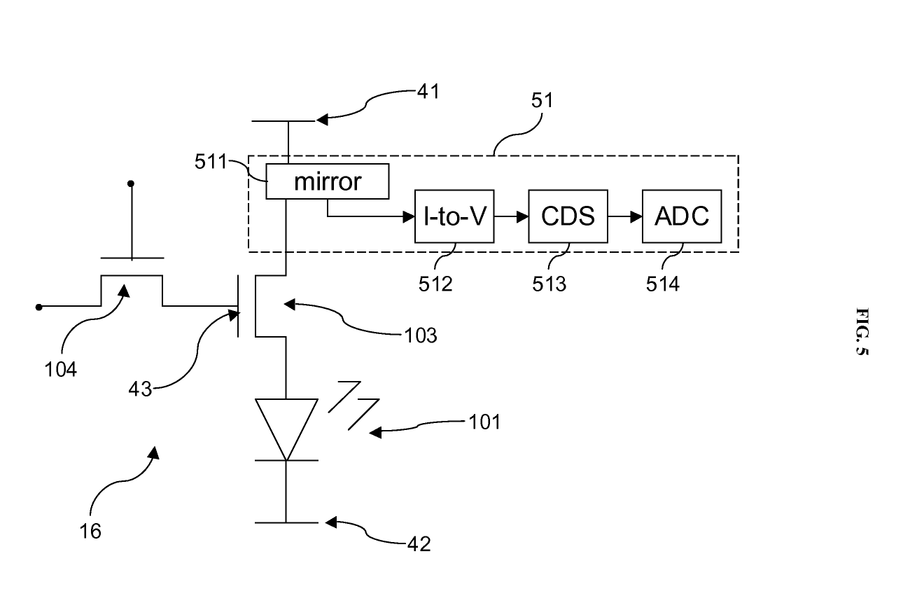

Signal-production circuitry 21 can employ several methods to provide an aging signal. Co-pending U.S. Ser. No. 11/962,182, by Leon et al., describes a method for measuring the current passing through each of the subpixels. Co-pending U.S. Ser. No. 11/766,823 describes a method for measuring a voltage associated with each drive circuit. Other methods obvious to those skilled in the art can also be employed with the present invention. Referring to FIG. 4, a 2T1C subpixel 16 as known in the art can comprise a drive transistor 103, select transistor 104, and EL device 101, as shown on FIG. 1. It can additionally comprise a gate electrode 43 of drive transistor 103, a first voltage source 41, and a second voltage source 42. These features will be used in discussion of several embodiments of signal-production circuitry.

Comparison circuitry 22 may comprise a comparator, which can compare the aging signal for a subpixel with a threshold level for that subpixel. The output of the comparator can be used as a staleness signal for that subpixel. Note that any comparison to see whether a value is below a threshold is analogous to a comparison to see whether a value is above a threshold. Such comparisons can therefore be employed with the present invention. Although the staleness signal is carrying yes-or-no information, it does not have to be digital; it can be analog, pulse-width modulated, or other forms known in the art. Measurements of the aging signal for each subpixel can be taken, and reverse bias applied, at predetermined intervals, after a predetermined time, or at times calculated based on what is shown on the display. Measurements can also be taken when measurements of a subpixel in the matrix or a representative subpixel indicate one or more subpixels are stale. For an electroluminescent panel including multiple subpixels, an aging signal and a staleness signal can be produced for each subpixel.

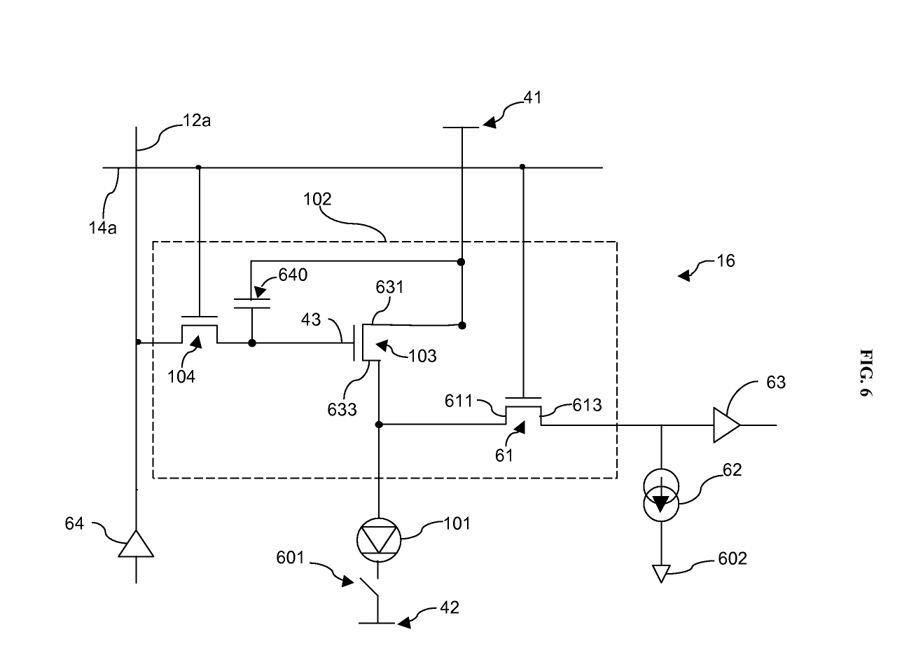

Referring to FIG. 5, in one embodiment, as taught in U.S. Ser. No. 11/962,182 by Leon et al., the aging signal can be the current passing through a subpixel, and the staleness signal can indicate that the subpixel current is below a predetermined threshold, or equivalently that the magnitude of the difference between measured current and some reference current is above a predetermined threshold. To this end, each subpixel 16 can include a first voltage source 41 electrically connected to the drive transistor 103 and a second voltage source 42 electrically connected to the electroluminescent device 101. The drive transistor can have a gate electrode 43 electrically connected to a select transistor 104, as shown in FIG. 4. Note that electrical connection can be made through switches, bus lines, conducting transistors, or other devices known in the art. Signal-producing circuitry 21, as shown in FIG. 2, can include a measuring circuit 51 for measuring the current passing through the first and second voltage sources at different times to provide an aging signal representing variations in the characteristics of the drive transistor and EL device caused by operation of the drive transistor and EL device over time. The aging signal can be the change in current between an initial measurement and a more recent measurement, expressed as a difference or a percentage. The measuring circuit can comprise, for example, a current mirror 511, current-to-voltage converter 512, correlated double-sampling unit 513, and analog-to-digital converter 514, as taught in U.S. Ser. No. 11/962,182 by Leon et al. The control signal can be compared to a threshold current to produce the staleness signal associated with each subpixel. Note that per Kirchoff's Current Law the measuring circuit can be attached anywhere in the current path through the drive transistor and EL device; for example, it can be attached between first voltage source 41 and drive transistor 103, or between electroluminescent device 101 and second voltage source 42. Similarly, the current can be measured through any node or nodes in the current path; for example, the current passing through the drain and source terminals of the drive transistor (631 and 633 of FIG. 6) can be measured.

Referring to FIG. 6, in another embodiment, in accordance with U.S. Ser. No. 11/766,823, the voltage across a test current sink can be proportional to a voltage associated with a drive circuit, specifically Vₜₕ of the drive transistor. This voltage, an aging signal, can be compared to a maximum desired Vₜₕ and the result of the comparison be used as a staleness signal. To this end, each subpixel 16 can be a three-transistor, one-capacitor (3T1C) subpixel to provide an aging signal that is a function of the threshold voltage of the subpixel's drive transistor.

Specifically, the subpixel matrix 15 of FIG. 1 can further include a first voltage source 41 and a current sink 62. The current sink can be electrically connected to a sink voltage source 602, which can be for example, a second voltage source 42 or ground. Each drive circuit 102 can include three transistors 103, 104, 61 as described herein. Each drive transistor 103 can further include a first electrode 631, which can be a drain terminal, electrically connected to the first voltage source 41, a second electrode 633, which can be a source terminal, and a gate electrode 43, which can be electrically connected to a select transistor 104. Each electroluminescent device 101 can be electrically connected to the second electrode of the drive transistor, and through a switch 601 to a second voltage source 42. Switch 601 can be closed for normal operation. It can be opened while measuring the aging signal to eliminate OLED leakage, which might otherwise cause measurement noise. The select transistor can be connected to row line for example 14a and column line for example 12a, as shown in FIG. 1, or to the appropriate row and column lines for each subpixel position in subpixel matrix 15. The subpixel 16 can also include a storage capacitor 640 as known in the art electrically connected to the gate electrode 43 of the drive transistor 103.

Each subpixel can further include a readout transistor 61 with a first electrode 611 electrically connected to the second electrode of the drive transistor, and a second electrode 613 electrically connected to the current sink 62. Either of the first and second electrodes can be either the source or drain of the readout transistor. The gate electrode 43 of the readout transistor can be electrically connected to the gate electrode of select transistor 104. The signal producing circuitry 21 can further include a test voltage source 64 electrically connected to the gate electrode 43 of the drive transistor, in this case through select transistor 104 as is known in the art. The test voltage source can be the source driver 11 or other circuitry integrated with the source driver 11, or separate circuitry.

Signal producing circuitry 21 can further include a voltage measurement circuit 63 electrically connected to the second electrode 613 of the readout transistor. In this embodiment, an aging signal that is a function of the threshold voltage of the subpixel's drive transistor can be provided by first setting the test voltage source 64 to a test potential, thus fixing V_{g}, the voltage of the gate electrode 43 of drive transistor 103. Next the current sink 62 can be set to a test current, thus fixing I_{ds}, as the test current drawn by the sink 62 is forced through the drive transistor 103 from electrode 631 to electrode 633. The voltage measurement circuit 63 can then be used to measure the voltage at the second electrode 613 of the readout transistor, which is electrically connected to second electrode 633 of the drive transistor, and can thus be at a potential equal to Vₛ, to provide the aging signal. Measuring Vₛ for a known V_{g} allows calculation of V_{gs}, which, at a given I_{ds}, fixes a point on the I-V curve of the transistor, allowing ΔVₜₕ to be determined by comparison with predetermined unaged characteristics of the drive transistor.

ΔVₜₕ or Vₛ can be used as the aging signal; either can represent variations in the characteristics of the drive transistor caused by the operation of the drive transistor over time. A comparator can determine whether ΔVₜₕ is above a threshold, or whether Vₛ is below a threshold, to provide a staleness signal. Note that there can be some potential drop across readout transistor 61. This and other effects can cause the aging signal not to be perfectly proportional to Vₜₕ. The present invention applies in these cases; corrections for such effects can be for example a fixed gain or offset adjustment.

Note that if the EL device is configured so that its cathode is connected to electrode 633, the typical direction of current flow in the drive transistor will be from electrode 633 to electrode 631, the opposite of the embodiment described above. The present invention applies to this case; a current source can be substituted for the current sink, and the measurements taken as described above.

A drive transistor can be reset by any of the methods known in the art for reverse bias. One possible method is changing the values of one or more external voltage supplies. Another is applying a negative gate-to-source voltage bias.

Referring back to FIG. 4, in one embodiment the reverse bias can be accomplished by providing each of the drive circuits 102 with first voltage source 41 and second voltage source 42 which during operation have a difference in potential and are the current supply through the associated drive transistor and EL device. In this case the resetting circuitry 23, as shown in FIG. 2, includes circuitry for changing the potential difference between the first and second voltage sources and applying a voltage on a gate electrode 43 of the drive transistor to cause the transistor to reset. A drive transistor can be reset by adjusting at least one of the voltage sources so that the first and second voltage sources have substantially equal potentials, and adjusting the gate electrode of the drive transistor to a potential which is different than the potential associated with the adjusted voltage sources. Substantially equal potentials can be defined, for example, as potentials within a selected tolerance (for example 5%) of each other. For example, for an N-channel drive transistor in a typical non-inverted configuration (for example FIG. 4), the gate potential can be less than the potential of the first and second voltage sources, making V_{gs} negative as Vₛ is greater than or equal to the potential of second voltage source 42. Adjusting the first and second voltage sources to have substantially equal potentials advantageously reduces current flow through the EL device during reverse bias, which reduces EL device degradation during the reverse bias phase.

For an electroluminescent panel including multiple subpixels, stale subpixels can be reverse-biased in this way. However, the fresh subpixels generally share the first and second voltage sources with the stale subpixels. To avoid reverse biasing fresh subpixels, the gates 43 of the fresh drive transistors can be driven to a potential which is substantially the same as the potentials associated with the adjusted first and second voltage sources, which are substantially equal during reverse bias as described above, or to a potential which introduces forward bias on the drive transistor with respect to the potentials of the adjusted voltage sources. Continuing the N-channel example above, the gates of fresh drive transistors can be driven to a potential greater than or equal to the potential of the adjusted voltage sources. Since the voltage sources have substantially equal potentials, no current will flow, and since the gate potential is the same or introduces forward bias, no reverse bias will occur. It can be advantageous to set the gate potential to introduce neither forward nor reverse bias, i.e. V_{gs}=0.

Parasitics, current flow through the EL device, AC coupling, and other effects can cause a voltage difference between the source of a drive transistor (for example 633) and the potential of the second voltage source (for example 42). They can also cause a difference between the output of a source driver (for example 11) and the potential applied to the gate electrode of a drive transistor (for example 43). For example, current flow can cause a voltage drop across EL device 101, or AC coupling across select transistor 104 as select line 12a changes state can cause the gate potential to be less than that supplied by the source driver. The gate potentials of fresh and stale drive transistors can be selected to produce the desired bias condition in the presence of these effects. An EL panel can be characterized to determine the magnitude of these effects, and the gate potentials, or potentials supplied by the source drivers, adjusted appropriately.

The invention has been described in detail with particular reference to certain preferred embodiments thereof, but it will be understood that variations and modifications can be effected within the spirit and scope of the invention. For example, the present invention can apply to any pixel circuit design. The above embodiments are constructed wherein the transistors in the drive circuits are n-channel transistors. It will be understood by those skilled in the art that embodiments wherein the transistors are p-channel transistors, or some combination of n-channel and p-channel, with appropriate well-known modifications to the circuits, can also be useful in this invention. Additionally, the embodiments described show the EL device in a non-inverted (common-cathode) configuration; this invention also applies to inverted (common-anode) configurations.

The above embodiments are further constructed wherein the transistors in the drive circuits are a-Si transistors. The present invention can apply to any active matrix backplane that is not stable as a function of time. For instance, transistors formed from organic semiconductor materials and zinc oxide are known to vary as a function of time and therefore this same approach can be applied to these transistors.

The invention has been described in detail with particular reference to certain preferred embodiments thereof, but it will be understood that variations and modifications can be effected within the spirit and scope of the invention.

### PARTS LIST

10 EL panel

11 source driver

12a column line

12b column line

12c column line

13 gate driver

14a row line

14b row line

14c row line

15 subpixel matrix

16 subpixel

21 signal-production circuitry

22 comparison circuitry

23 resetting circuitry

24 signal-storage circuitry

31 curve without reverse bias

32 curve with reverse bias

33 line

41 first voltage source

42 second voltage source

43 gate electrode

51 current-measurement circuitry

61 readout transistor

62 current sink

63 voltage measurement circuit

64 test voltage source

101 electroluminescent device

102 drive circuit

103 drive transistor

104 select transistor

511 current mirror

512 current-to-voltage converter

513 correlated double-sampling unit

514 analog-to-digital converter

601 switch

602 sink voltage source

611 first electrode

613 second electrode

631 first electrode

633 second electrode

640 storage capacitor

1. A method for resetting drive transistors associated with subpixels in an electroluminescent display, comprising:
a) providing an electroluminescent display having a plurality of subpixels, each subpixel including an electroluminescent device and a drive circuit having a drive transistor for providing current through its associated electroluminescent device;
b) providing a separate aging signal for each subpixel during operation of the electroluminescent display after a predetermined operating time period by responding as a function of the current passing through each of the subpixels or as a function of a voltage associated with each drive circuit;
c) comparing each of the separate aging signals with a corresponding threshold level to produce a separate staleness signal for each subpixel representing whether or not the associated drive transistor should be reset; and
d) resetting the associated drive transistors in response to staleness signals that indicate such drive transistors should be reset.

2. The method of claim 1 wherein step d further includes providing a first voltage source and a second voltage source which have a difference in potential and supply current through the associated drive transistor and electroluminescent device during operation; adjusting at least one of the voltage sources so that the first and second voltage sources have substantially equal potentials; and adjusting the gate of the drive transistor to a potential which is different than the potential associated with the adjusted voltage sources.

3. The method of claim 1 wherein step b further includes measuring the current passing through drain and source terminals of a drive transistor to provide an aging signal.

4. The method of claim 1 wherein step b further includes providing a test voltage to a gate electrode associated with a drive transistor; forcing a test current through the drive transistor; and measuring the voltage at a source electrode of the drive transistor to provide an aging signal.

5. The method of claim 1 wherein the threshold levels for all subpixels are equal.

6. Apparatus for resetting drive transistors associated with subpixels in an electroluminescent display, comprising:
a) an array of subpixels, each subpixel including an electroluminescent device and a drive circuit having a drive transistor for providing current through its associated electroluminescent device;
b) means effective after a predetermined operating time cycle of the electroluminescent display for producing a separate aging signal for each subpixel that is a function of current passing through its associated drive transistor or voltage associated with its associated drive circuit;
c) means for comparing each of the separate aging signals with a corresponding threshold level to produce a separate staleness signal for each subpixel indicating whether or not its associated drive transistor should be reset; and
d) means employing reverse bias to reset the drive transistors associated with staleness signals that indicate such drive transistors should be reset.

7. The apparatus of claim 6 wherein each of the drive circuits includes first and second voltage sources which have a difference in potential and supply current through the associated drive transistor and electroluminescent device during operation; and wherein the resetting means further includes means for changing the potential difference between the first and second voltage sources and applying a voltage on a gate electrode of the drive transistor to cause such transistor to reset.

8. The apparatus of claim 6 wherein the resetting means reverse biases each drive transistor in a time period greater than one frame time.

9. The apparatus of claim 8 further including means for storing a progress signal representing that a drive transistor should be reverse biased and applying such reverse bias during one or more time periods when the display is not operating.

10. The apparatus of claim 6 wherein each subpixel further includes a first voltage source electrically connected to the drive transistor and a second voltage source electrically connected to the electroluminescent device, and wherein the signal producing means includes a measuring circuit for measuring the current passing through the first and second voltage sources at different times to provide an aging signal representing variations caused by operation of the drive transistor and electroluminescent device over time.

11. The apparatus of claim 6 wherein:
the subpixel array further includes a first voltage source and a current sink;
each drive transistor further includes a first electrode electrically connected to the first voltage source, a second electrode, and a gate electrode;
each electroluminescent device is electrically connected to the second electrode of the drive transistor;
each subpixel further includes a readout transistor with a first electrode electrically connected to the second electrode of the drive transistor and a second electrode electrically connected to the current sink;
and the signal producing means further includes a test voltage source electrically connected to the gate electrode of the drive transistor and a voltage measurement circuit electrically connected to the second electrode of the readout transistor to provide an aging signal representing variations caused by operation of the drive transistor over time.
